(19) United States
(12) Patent Application Publication
(10) Pub. No.: US 2015/0047180 A1
(43) Pub. Date: Feb. 19, 2015

(54) BATTERY MANUFACTURING

(71) Applicant: THE GILLETTE COMPANY, Boston, MA (US)

(72) Inventors: Arne Martin Schmidt, Eschborn (DE); Hans-Herbert Fuchs, Hofheim am Taunus (DE)

(73) Assignee: THE GILLETTE COMPANY, Boston, MA (US)

(21) Appl. No.: 13/966,584

(22) Filed: Aug. 14, 2013

(51) Int. Cl. H01M 6/00

(52) U.S. Cl. CPC H01M 6/005
USPC 29/623.1

(57) ABSTRACT

A method of manufacturing a battery is provided. A cathode assembly is provided, including a cathode and a cathode tab. The cathode tab is welded to a positive terminal of the battery. The welding is made in a circular movement.

### FIELD OF THE INVENTION

This invention relates to battery manufacturing, and more particularly to a method of welding a cathode to a portion of the battery with which it is in electrical communication in the finished battery.

### BACKGROUND OF THE INVENTION

A battery generally includes a cathode, an anode, and an electrolyte, disposed in a housing, often referred to as a “can” or “casing.”

The cathode may in some cases be prepared in the form of a slurry which contains solids which include the cathode active material, conductive carbon particles, and binder. Solvents are added to dissolve the binder and provide good dispersion and mixing of the solid components in the slurry. The cathode slurry is coated onto one or both sides of a thin conductive substrate, and then dried to evaporate the solvents and leave a dry cathode coating on one or both sides of the substrate, forming a cathode composite sheet.

A cell electrode assembly is formed with a sheet of anode material, for example lithium, the cathode composite sheet containing the cathode active material, and a separator between the anode and cathode. The electrode assembly may be spirally wound and inserted into the cell casing, for example, as shown in U.S. Pat. No. 4,707,421. A portion of the anode sheet (e.g., an anode tab) is typically electrically connected to the cell casing which forms the cell's negative terminal. The cell is closed with an end cap which is insulated from the casing. A cathode tab extending from the cathode composite sheet is electrically connected to the end cap which forms the cell's positive terminal, for example by welding. The casing is typically crimped over the peripheral edge of the end cap to seal the casing's open end.

In some cases, it is difficult to weld the cathode tab to the end cap. For example, if the cathode tab and the end cap are made of aluminum, it is difficult to weld the components together without welding-through the relatively thin layers thereby creating welds of inferior strength leading to damage to and break-off of the cathode tab.

### SUMMARY OF THE INVENTION

The present invention provides a method of manufacturing a battery. The method comprises providing a battery housing including a housing body and a portion defining a positive battery terminal; providing an electrode assembly comprising a cathode and a cathode tab configured to allow the cathode to be connected to the positive battery terminal; and welding together the cathode tab and the positive battery terminal, said welding being made in a circular movement.

The invention also features batteries manufactured using the methods disclosed herein.

The details of one or more embodiments of the invention are set forth in the accompanying drawings and the description below. Other features and advantages of the invention will be apparent from the description and drawings, and from the claims.

### BRIEF DESCRIPTION OF THE DRAWINGS

FIG. 1 is a cross-sectional view of the upper portion of a cylindrical battery.

FIG. 2 is a flow diagram illustrating a process according to the present invention.

FIG. 3 is a plan view of the cathode tab welded to the positive battery terminal.

FIG. 4 is a cross-sectional view of the cathode tab welded to the positive battery terminal.

### DETAILED DESCRIPTION OF THE INVENTION

In the methods disclosed herein, a cathode tab and a portion of the battery are welded together using a circular movement to provide a reliable, high strength weld to be formed between the two parts.

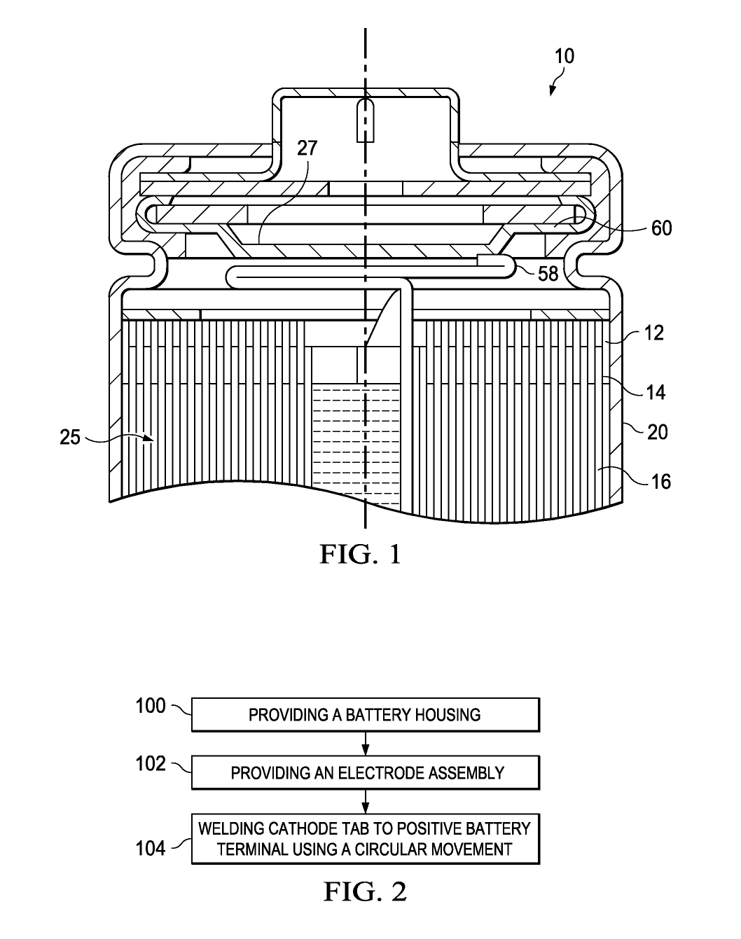

An example of a battery or cell 10 is shown in FIG. 1. Cell 10 includes a housing body or “can” 20, an anode sheet 12, which may, for example, comprise lithium metal or other anode active material, a separator 14, and a cathode sheet 16. The cathode sheet 16 includes a cathode active material. If the anode comprises lithium metal, the cathode active material can be, for example, iron disulfide (FeS₂). In some implementations, the anode, cathode, and separator define a spiral wound electrode assembly 25, as shown, which can be prepared by spirally winding a flat electrode composite. The cell also includes an electrolyte.

The cell 10 may be cylindrical, or may be in the form of a spirally wound flat cell or prismatic cell, for example a rectangular cell having the overall shape of a cuboid. For a spirally wound cell, a preferred shape of the housing 20 is cylindrical, as shown in FIG. 1.

In some implementations, the cathode active is coated on a cathode substrate, e.g., aluminum foil or stainless steel, to form a cathode composite sheet. In such implementations, the cathode substrate can function as a current collector. A cathode tab 58, which can be formed, for example, of Aluminum 1145, is then attached, e.g., ultrasonically welded, to the cathode substrate. The cathode tab may have any desired dimensions. It may, for example, be about 50 to 60 mm long, 4 to 6 mm wide, and 0.05 to 0.15 mm thick, e.g., 0.09 to 0.11 mm thick. The thickness is selected to facilitate processing as well as enhance the current carrying capability of the product. Aluminum is preferred for its positive polarity and because aluminum is electrochemically stable at the potential encountered in use. In some implementations, the cathode tab is located at the lead edge of the cathode. However, the tab can be located anywhere along the cathode length. It can be desirable to have the cathode tab and anode tab at opposite ends of the electrode assembly as this provides uniform current distribution and hence uniform discharge along the entire length of the electrode assemble.

During cell assembly, the cathode tab 58 is connected to the positive terminal 60 of the battery 10. The positive terminal 60 comprises an assembly that includes multiple parts. One of the parts of the positive terminal 60 is a contact cup 27. Contact cup 27 can be made, for example, of Aluminum 5052 H34, and generally includes a safety vent. The aluminum cathode tab 58 is welded to this contact cup 27, e.g., by laser welding.

The cathode tab 58 and the contact cup 27 to which it is welded are generally both relatively thin, making them particularly susceptible to welding damage. For example, the cathode tab 58 is between about 0.05 mm and 0.2 mm thick, preferably about 0.1 mm thick, while the contact cup 27 to which it is being welded is between about 0.2 mm and 0.5 mm thick, preferably about 0.3 mm thick.

FIG. 2 illustrates a process for welding the cathode tab 58 to the contact cup 27 (or to any other suitable area of the battery). First, in step 100, a battery housing is provided. The battery housing includes a housing body and a positive battery terminal. Next, in step 102, an electrode assembly is provided. The electrode assembly comprises a cathode and a cathode tab configured to allow the cathode to be connected to the positive battery terminal. The electrode assembly may also include an anode and a separator. Alternatively, the anode and separator may be provided separately depending on the battery construction. The electrode assembly is assembled into a can or other suitable housing, and an end cap assembly is provided which will seal the housing in the finished battery and form the positive terminal of the battery.

Finally, in step 104, the cathode tab and the contact cup (or other area of the positive battery terminal) are welded together. Welding is performed using a laser beam emitted from a fiber laser. The welding of the cathode tab to the positive battery terminal is made in a circular movement.

A suitable fiber laser is the laser system commercially available from Trumpf under the trade name TruFiber 200. The fiber laser may, for example, generate a beam having a diameter between about 5 microns and about 50 microns, run at a power of between about 50 W and about 200 W. The beam may be moved at a rate of between about 100 mm/sec and 1000 mm/sec, preferably at a rate of about 500 mm/sec.

Preferably, substantially the entire weld area is cleaned prior to welding. If desired, the entire area of the cathode tab and/or the entire area of the contact cup may be cleaned prior to welding.

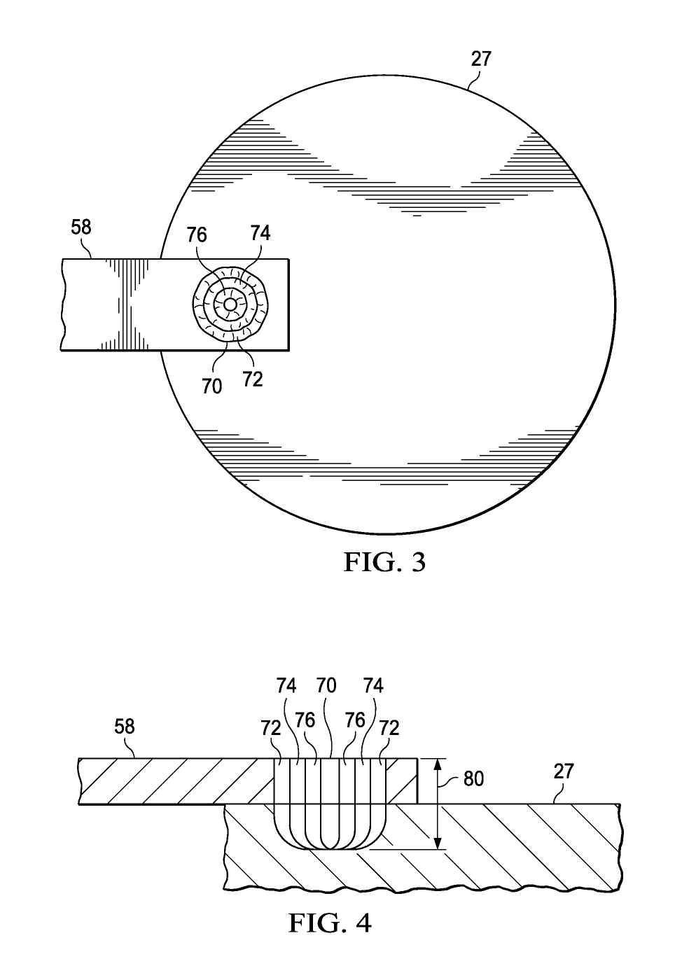

Referring now to FIGS. 3 and 4, there is shown a cathode tab 58 welded to the contact cup 27 of the positive battery terminal. Cathode tab 58 is welded to contact cup 27 with a weld 70. Weld 70 is created by moving a fiber laser in a circular movement. The circular movements may be made in a wide range of diameters, with a range of between about 100 microns and about 1000 microns being preferred. As can be seen weld 70 comprises a first circular weld 72. Circular weld 72 has a diameter of about 300 microns. Circular weld 72 may be created in a single circular movement or by multiple repeated circular movements. The fiber laser is then adjusted to a second smaller diameter to create a second circular weld 74 having a diameter smaller than that of the first circular weld 72. Second circular weld 74 has a diameter of about 200 microns. Circular weld 74 may be created in a single circular movement or by multiple repeated circular movements. The fiber laser is then adjusted to a third smaller diameter to create a third circular weld 76 having a diameter smaller than that of the second circular weld 74. Third circular weld 76 has a diameter of about 100 microns. Circular weld 76 may be created in a single circular movement or by multiple repeated circular movements. The welds are preferably spaced sufficiently apart from one another to allow for the heat flow from each weld.

While weld 70 is shown with three circular welds, any number of circular welds may be used to secure to secure the cathode tab to the positive battery terminal.

As a result of the multiple circular weld movements, weld 70 has a substantially uniform depth 80 providing for a strong weld. The depth 80 of weld 70 is preferably between about 0.1 mm and about 0.3 mm, preferably about 0.15 mm.

A number of embodiments of the invention have been described. Nevertheless, it will be understood that various modifications may be made without departing from the spirit and scope of the invention.

The cell may be of any size, for example, AAAA (40.2×8.4 mm), AAA (44.5×10.5 mm), AA (50×14 mm), C (49.2×25.5 mm), or D (60.5×33.2 mm) size. Cell 10 may also be a “⅔ A” cell (33.5×16.2 mm) or a CR2 cell (26.6×15.3 mm).

While a cell construction having a single anode tab and single cathode tab has been discussed above, multiple anode tabs and/or multiple cathode tabs can be used in some implementations, for example when a high current drain is desired.

The method of the present invention has been discussed in the context of welding a cathode tab to a positive battery terminal where each are comprised of aluminum. In addition, the current method may be carried out on other non-ferrous metal weldings and in particular with batteries and accumulators.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. Further, as used herein, where a group is described to be “comprising of” a list of group members, that group may also “consist essentially of” or “consist Of” that same list of group members.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of manufacturing a battery, the method comprising:
providing a battery housing including a housing body and a portion defining a positive battery terminal;
providing an electrode assembly comprising a cathode and a cathode tab configured to allow the cathode to be connected to the positive battery terminal; and
welding together the cathode tab and the positive battery terminal, said welding being made in a circular movement.

2. The method of claim 1 wherein the circular movement is repeated multiple times about the same diameter.

3. The method of claim 1 wherein said welding is made in multiple circular movements each having different diameters.

4. The method of claim 1 wherein said welding is made in a first circular movement having a first diameter and a second circular movement having a second diameter different from the first diameter.

5. The method of claim 4 wherein the first circular movement is repeated multiple times about the first diameter before moving to the second circular movement.

6. The method of claim 1 wherein welding comprises laser welding.

7. The method of claim 6 wherein the laser beam comprises a fiber laser.

8. The method of claim 7 wherein the laser beam emitted from the fiber laser has a diameter between 5 and 50 microns.

9. The method of claim 1 wherein the cathode tab has a thickness between 0.05 mm and 0.2 mm.

10. The method of claim 1 wherein the positive battery terminal has a thickness between 0.2 mm and 0.5 mm.

11. The method of claim 1 wherein the circular welding movement is a made at a diameter between 100 and 1000 microns.

12. The method of claim 1 wherein the cathode tab comprises aluminum.

13. The method of claim 1 wherein the positive battery terminal comprises aluminum.
